(19) United States
(12) Patent Application Publication
(10) Pub. No.: US 2005/0013970 A1
(43) Pub. Date: Jan. 20, 2005

(54) Multi-layer product in which the co-extruded side is easily recognizable

(76) Inventors: Rudiger Gorny, Moon Twp, PA (US); Siegfried Anders, Koln (DE); Wolfgang Nising, Sankt Augustin (DE); Claus Rudiger, Krefeld (DE)

Correspondence Address: BAYER MATERIAL SCIENCE LLC, 100 BAYER ROAD, PITTSBURGH, PA, 15205, US

(21) Appl. No.: 10/889,296

(22) Filed: Jul. 12, 2004

(30) Foreign Application Priority Data
Jul. 14, 2003 (DE) 10331670.1

(51) Int. Cl. B32B 3/10

(52) U.S. Cl. 428/133

(57) ABSTRACT

A multi-layer product which is produced by co-extrusion and in which the co-extruded side is easily recognizable is disclosed. The product comprises a base layer containing a transparent thermoplastic and at least one co-extruded layer that contains a transparent thermoplastic and is different from the base layer. Also disclosed is a process for the production of such a multi-layer product and products containing such a multi-layer product.

### FILED OF THE INVENTION

The present invention relates to a co-extruded multi-layer article and in particular to an article in which the co-extruded side is easily recognizable.

### SUMMARY OF THE INVENTION

A multi-layer product which is produced by co-extrusion and in which the co-extruded side is easily recognizable is disclosed. The product comprises a base layer containing a transparent thermoplastic and at least one co-extruded layer that contains a transparent thermoplastic and is different from the base layer. Also disclosed is a process for the production of such a multi-layer product and products containing such a multi-layer product.

### BACKGROUND OF THE INVENTION

Products which contain a transparent thermoplastic and are produced by extrusion are frequently provided with a co-extruded layer on one of the outer sides. For example, multi-wall sheets and solid sheets made of polycarbonate are frequently produced with a UV co-extruded layer on one of the outer sides in order to protect them from damage (e.g. yellowing) by UV light.

When fitting a multi-layer product, for example on the building site, it is often not readily possible to recognize which side is the co-extruded side. When producing UV-protected solid or multi-wall sheets, for example, the side provided with a UV co-extruded layer is generally provided with an inscribed film. This film indicates the UV-protected side, that is to say, for example, the side that must face the sun when the sheet is fitted into a greenhouse.

Once the protective film has been removed, it is generally no longer possible to see by simple means, on the building site, which side is the UV co-extruded side. Consequently, sheets with UV protection on one side are frequently fitted incorrectly, with the result that they are rapidly damaged by environmental influences and have to be replaced.

There is therefore a need to provide solid and multi-layer sheets in which the UV co-extruded side is easily recognizable even after the protective film has been removed.

WO 98/19862 A1 discloses multi-layer sheets containing optical brighteners in the co-extruded layer. The optical brightener ensures that the co-extruded layer begins to glow when irradiated with a light source containing UV light. A disadvantage is, however, that such a lamp is not present on every building site.

### BRIEF DESCRIPTION OF THE DRAWING

FIG. 1 is a cross section of a multi layered, multi-wall sheet.

### DETAILED DESCRIPTION OF THE INVENTION

Starting from the known prior art and its described disadvantages, the problem arises of providing a multi-layer product in which the co-extruded side is easily recognizable without further aids even after the removal of any protective film that may be present.

Surprisingly, it has now been found that this object is achieved by the multi-layer product according to the invention that is described hereinbelow.

The present invention accordingly provides a multi-layer product which is produced by co-extrusion and comprises a base layer containing a transparent thermoplastic and at least one co-extruded layer that contains a transparent thermoplastic and is different from the base layer, which multi-layer product is characterised in that the co-extruded layer is in such a form that it extends at regular intervals into the base layer in substantially wedge-shaped spurs.

It is possible for the mentioned wedge-shaped spurs either to extend only partly into the base layer of the multi-layer product or, in the case of multi-wall sheets, to extend through the entirety of the base layer.

When the co-extruded side is viewed from above, the wedge-shaped spurs of the co-extruded layer appear as thin lines and therefore allow the co-extruded side to be recognized reliably without further aids or markings. The lines cannot be seen from afar, so that the visual appearance of the sheets when fitted is not impaired.

The wedge-shaped spurs of the co-extruded layer additionally serve to anchor the latter in the base layer and thus prevent undesirable delamination of the co-extruded layer.

A preferred embodiment of the multi-layer product according to the invention is a solid or multi-wall sheet that contains a transparent thermoplastic, especially polycarbonate, and is protected against UV rays on one side by a co-extruded layer containing at least one UV absorber.

Such solid sheets may have various thicknesses, e.g. from 0.6 to 15 mm, and they may be corrugated. Such multi-wall sheets may be twin-wall sheets, triple-wall sheets, quadruple-wall sheets etc. The multi-wall sheets may also possess different profiles, e.g. X-shaped profiles or XX-shaped profiles. The multi-wall sheets may additionally be either flat or corrugated.

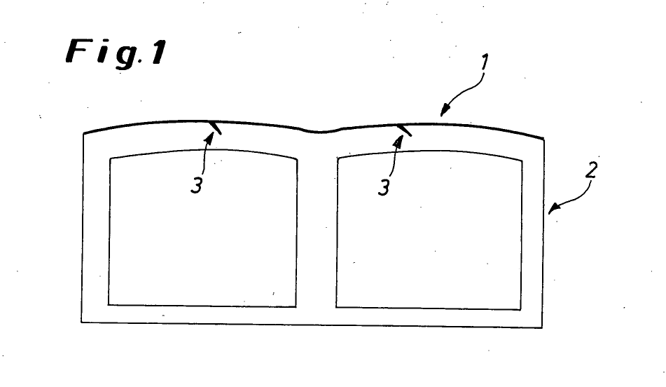

In the case of a multi-wall sheet, the wedge-shaped spurs of the co-extruded layer may be located either above the walls or at the bands between the walls. In a preferred embodiment, at least some of the wedge-shaped spurs of the co-extruded layer are located between the walls of the multi-wall sheet. FIG. 1 shows by way of example a multi-wall sheet according to the invention, wherein the co-extruded layer, 1, is shown by the dark area. Spurs, 3, are anchored in the wall of the multi-wall sheet, 2.

A particularly preferred embodiment of the present invention is a two-layer sheet containing a layer of polycarbonate and of a co-extruded layer of (co)polycarbonate or (co)polyester or a polycarbonate-polyester blend or a (co)polymethyl methacrylate.

A further particularly preferred embodiment of the present invention is a three-layer sheet containing a layer of polycarbonate as the base layer and two co-extruded layers located thereon which may be identical or different and consist of (co)polycarbonate or (co)polyester or a polycarbonate-polyester blend or a (co)polymethyl methacrylate.

Suitable transparent thermoplastics for the production of the multi-layer products according to the invention are, for example, polycarbonate, copolyester carbonates, polyesters, copolyesters, blends of polycarbonate and polyesters or copolyesters, polymethyl methacrylate, polyethyl methacrylate, styrene-acrylonitrile copolymers or mixtures thereof; polycarbonate, copolyester carbonates, polyesters, copolyesters, transparent blends of polycarbonate and polyesters or copolyesters are preferred; polycarbonate is very particularly preferred.

Suitable polycarbonates for the production of the multi-layer products according to the invention are any known polycarbonates. They are homopolycarbonates, copolycarbonates and thermoplastic polyester carbonates.

Suitable polycarbonates preferably have mean molecular weights \overline{M}_{w} of from 18,000 to 40,000, preferably from 26,000 to 36,000 and especially from 28,000 to 35,000, determined by measuring the relative solution viscosity in dichloro-methane or in mixtures of equal amounts by weight of phenol/o-dichlorobenzene calibrated by light scattering.

For the preparation of polycarbonates, reference is made by way of example to “Schnell, Chemistry and Physics of Polycarbonates, Polymer Reviews, Vol. 9, Interscience Publishers, New York, London, Sydney 1964” and to “D. C. PREVORSEK, B. T. DEBONA and Y. KESTEN, Corporate Research Center, Allied Chemical Corporation, Morristown, N.J. 07960, ‘Synthesis of Poly(ester)carbonate Copolymers’ in Journal of Polymer Science, Polymer Chemistry Edition, Vol. 19, 75-90 (1980)” and to “D. Freitag, U. Grigo, P. R. Müller, N. Nouvertne, BAYER A G, ‘Polycarbonates’ in Encyclopedia of Polymer Science and Engineering, Vol. 11, Second Edition, 1988, pages 648-718” and finally to “Dres. U. Grigo, K. Kircher and P. R. Müller ‘Polycarbonate’ in Becker/Braun, Kunststoff-Handbuch, Volume 3/1, Polycarbonate, Polyacetale, Polyester, Celluloseester, Carl Hanser Verlag Munich, Vienna 1992, pages 117-299”.

The preparation of the polycarbonates is preferably carried out by the interfacial process or by the melt transesterification process and is described hereinbelow with reference to the example of the interfacial process.

Compounds that are preferred for use as starting materials are bisphenols of the general formula
HO-Z-OH,
wherein
Z is a divalent organic radical having from 6 to 30 carbon atoms which contains one or more aromatic groups.

Examples of such compounds are bisphenols belonging to the group of the dihydroxydiphenyls, bis(hydroxyphenyl)alkanes, indanebisphenols, bis(hydroxy-phenyl) ethers, bis(hydroxyphenyl)sulfones, bis(hydroxyphenyl) ketones and α,α′-bis(hydroxyphenyl)-diisopropylbenzenes.

Particularly preferred bisphenols belonging to the above-mentioned groups of compounds are bisphenol A, tetraalkylbisphenol A, 4,4-(meta-phenylene-diisopropyl)-diphenol (bisphenol M), 4,4-(para-phenylenediisopropyl)-diphenol, 1,1-bis-(4-hydroxyphenyl)-3,3,5-trimethylcyclohexane (bisphenol TMC) and mixtures thereof.

The bisphenol compounds to be used according to the invention are preferably reacted with carbonic acid compounds, especially phosgene, or, in the case of the melt transesterification process, with diphenyl carbonate or dimethyl carbonate.

Polyester carbonates are preferably obtained by reaction of the above-mentioned bisphenols, at least one aromatic dicarboxylic acid and, optionally, carbonic acid equivalents. Suitable aromatic dicarboxylic acids are, for example, phthalic acid, terephthalic acid, isophthalic acid, 3,3′- or 4,4′-diphenyldicarboxylic acid and benzophenonedicarboxylic acids. It is possible for some, up to 80 mol. %, preferably from 20 to 50 mol. %, of the carbonate groups in the polycarbonates to be replaced by aromatic dicarboxylic acid ester groups.

Inert organic solvents used in the interfacial process are, for example, dichloromethane, the various dichloroethanes and chloropropane compounds, tetrachloromethane, trichloromethane, chlorobenzene and chlorotoluene, with preference being given to the use of chlorobenzene or dichloromethane or mixtures of dichloromethane and chlorobenzene.

The interfacial reaction may be accelerated by catalysts such as tertiary amines, especially N-alkylpiperidines or onium salts. Tributylamine, triethylamine and N-ethylpiperidine are preferably used. In the case of the melt transesterification process, the catalysts mentioned in DE-A 42 38 123 are preferably used.

The polycarbonates may be branched in a deliberate and controlled manner by the use of small amounts of branching agents. Some suitable branching agents are: phloroglucinol, 4,6-dimethyl-2,4,6-tri-(4-hydroxyphenyl)-heptene-2; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenylmethane; 2,2-bis-[4,4-bis-(4-hydroxyphenyl)-cyclohexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-isopropyl)-phenoxy)-methane; α,α′,α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and especially: 1,1,1-tri-(4-hydroxyphenyl)-ethane and bis-(3-methyl-4-hydroxyphenyl)-2-oxo-2,3-dihydroindole.

The 0.05 to 2 mol. %, based on diphenols used, of branching agents or mixtures of branching agents that are optionally to be used concomitantly may be used together with the diphenols or alternatively may be added at a later stage of the synthesis.

There are preferably used as chain terminators phenols such as phenol, alkylphenols such as cresol and 4-tert.-butylphenol, chlorophenol, bromophenol, cumylphenol or mixtures thereof, in amounts of from 1 to 20 mol. %, preferably from 2 to 10 mol. %, per mole of bisphenol. Phenol, 4-tert.-butylphenol and cumylphenol are preferred.

Chain terminators and branching agents may be added to the syntheses separately or together with the bisphenol.

The preparation of the polycarbonates by the melt transesterification process is described by way of example in DE-A 42 38 123.

Polycarbonates that are preferred according to the invention are the homopolycarbonate based on bisphenol A, the homopolycarbonate based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane and the copolycarbonates based on the two monomers bisphenol A and 4,4′-dihydroxy-diphenyl (DOD).

The homopolycarbonate based on bisphenol A is particularly preferred.

Both the base layer and the co-extruded layer(s) of the multi-layer products according to the invention may additionally contain additives such as, for example, UV absorbers and also other conventional processing aids, especially mold-release agents and flow agents as well as the stabilizers, especially thermal stabilizers, conventional for polycarbonates and also antistatics, colorings, optical brighteners and inorganic pigments. It is possible for different additives or concentrations of additives to be present in each layer.

In particular, the co-extruded layer may contain UV absorbers and mold-release agents.

Suitable stabilizers are, for example, phosphines, phosphites or Si-containing stabilizers and further compounds described in EP-A 0 500 496. Examples which may be mentioned include triphenyl phosphites, diphenylalkyl phosphites, phenyldialkyl phosphites, tris-(nonylphenyl) phosphite, tetrakis-(2,4-di-tert.-butylphenyl)-4,4′-biphenylene diphosphonite, bis(2,4-dicumylphenyl)pentaery-thritol diphosphite and triaryl phosphite. Triphenylphosphine and tris-(2,4-di-tert.-butyl-phenyl) phosphite are particularly preferred.

Suitable mold-release agents are, for example, the esters or partial esters of mono- to hexa-hydric alcohols, especially of glycerol, of pentaerythritol or of Guerbet alcohols.

Monohydric alcohols are, for example, stearyl alcohol, palmityl alcohol and Guerbet alcohols; a dihydric alcohol is, for example, glycol; a trihydric alcohol is, for example, glycerol; tetrahydric alcohols are, for example, pentaerythritol and mesoerythritol; pentahydric alcohols are, for example, arabitol, ribitol and xylitol; hexahydric alcohols are, for example, mannitol, glucitol (sorbitol) and dulcitol.

The esters are preferably the monoesters, diesters, triesters, tetraesters, pentaesters and hexaesters or mixtures thereof, especially random mixtures, of saturated aliphatic C₁₀- to C₃₆-monocarboxylic acids and optionally hydroxy-monocar-boxylic acids, preferably with saturated aliphatic C₁₄- to C₃₂-monocarboxylic acids and optionally hydroxy-monocarboxylic acids.

The commercially available fatty acid esters, especially of pentaerythritol and of glycerol, may contain, on account of the preparation, <60% of different partial esters.

Saturated aliphatic monocarboxylic acids having from 10 to 36 carbon atoms are, for example, capric acid, lauric acid, myristic acid, palmitic acid, stearic acid, hydroxystearic acid, arachidic acid, behenic acid, lignoceric acid, cerotic acid and montanic acids.

Preferred saturated aliphatic monocarboxylic acids having from 14 to 22 carbon atoms are, for example, myristic acid, palmitic acid, stearic acid, hydroxystearic acid, arachidic acid and behenic acid.

Particular preference is given to saturated aliphatic monocarboxylic acids such as palmitic acid, stearic acid and hydroxystearic acid.

The saturated aliphatic C₁₀- to C₃₆-carboxylic acids and the fatty acid esters are either known as such in the literature or may be prepared by processes known in the literature. Examples of pentaerythritol fatty acid esters are those of the particularly preferred monocarboxylic acids mentioned above.

Particular preference is given to esters of pentaerythritol and of glycerol with stearic acid and palmitic acid.

Esters of Guerbet alcohols and of glycerol with stearic acid and palmitic acid and, optionally, hydroxystearic acid are also particularly preferred.

Examples of suitable antistatics are cationic compounds, for example quaternary ammonium, phosphonium or sulfonium salts, anionic compounds, for example alkylsulfonates, alkyl sulfates, alkyl phosphates, carboxylates in the form of alkali metal or alkaline earth metal salts, non-ionic compounds, for example polyethylene glycol esters, polyethylene glycol ethers, fatty acid esters, ethoxylated fatty amines. Preferred antistatics are non-ionic compounds.

Suitable UV absorbers are, for example

a) benzotriazole derivatives according to formula (I):

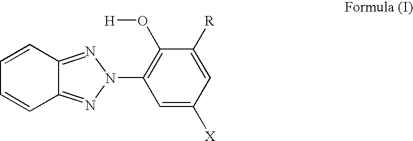

In formula (I), R and X are identical or different and represent H or alkyl or alkylaryl.

Of those compounds, preference is given to Tinuvin® 329 where X=1,1,3,3-tetramethylbutyl and R═H

Tinuvin® 350 where X=tert.-butyl and R=2-butyl

Tinuvin® 234 where X═R=1,1-dimethyl-1-phenyl

b) dimeric benzotriazole derivatives according to formula (II):

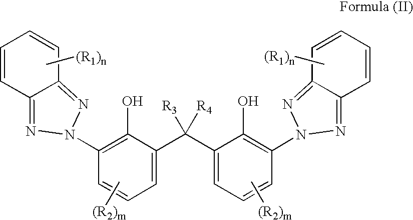

In formula (II), R₁ and R₂ are identical or different and represent H, halogen, C₁-C₁₀-alkyl, C₅-C₁₀-cycloalkyl, C₇-C₁₃-aralkyl, C₆-C₁₄-aryl, —OR⁵ or —(CO)—O—R⁵ wherein R⁵═H or C₁-C₄-alkyl.

In formula (II), R₃ and R₄ are likewise identical or different and represent H, C₁-C₄-alkyl, C₅-C₆-cycloalkyl, benzyl or C₆-C₁₄-aryl.

In formula (II), m represents 1, 2 or 3 and n represents 1, 2, 3 or 4.

Of those compounds, preference is given to Tinuvin® 360 where R₁═R₃═R₄═H; n=4; R₂=1,1,3,3-tetramethylbutyl; m=1

b1) dimeric benzotriazole derivatives according to formula (III): 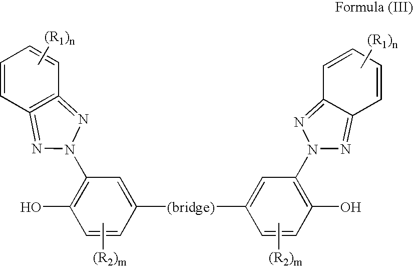
wherein the bridge represents 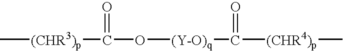
R₁, R², m and n are as defined for formula (II),
and wherein p is an integer from 0 to 3,
q is an integer from 1 to 10,
Y is —CH₂—CH₂—, —(CH₂)₃—, —(CH₂)₄—, —(CH₂)₅—, —(CH₂)₆— or CH(CH₃)—CH₂—, and
R³ and R4 are as defined for formula (II).

Of those compounds, preference is given to Tinuvin® 840 where R₁═H; n=4; R₂=tert.-butyl; m=1; R₂ is attached in the ortho-position relative to the OH group; R₃═R₄═H; p=2; Y═—(CH₂)₅—; q=1

c) triazine 2d derivatives according to formula (IV): 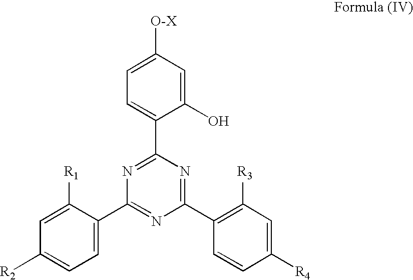
wherein R₁, R₂, R₃, R₄ in formula (IV) are identical or different and are H or alkyl or CN or halogen, and X is alkyl.

Of those compounds, preference is given to Tinuvin® 1577 where R₁═R₂═R₃═R₄═H; X=hexyl

Cyasorb® UV-1164 where R₁═R₂═R₃═R₄=methyl; X=octyl

d) triazine derivatives of the following formula (IVa) 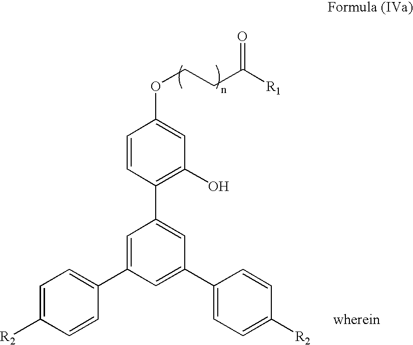
R₁ is C₁-alkyl to C₁₇-alkyl,
R₂ is H or C₁-alkyl to C₄-alkyl, and
n is from 0 to 20

e) dimeric triazine derivatives of formula (V): 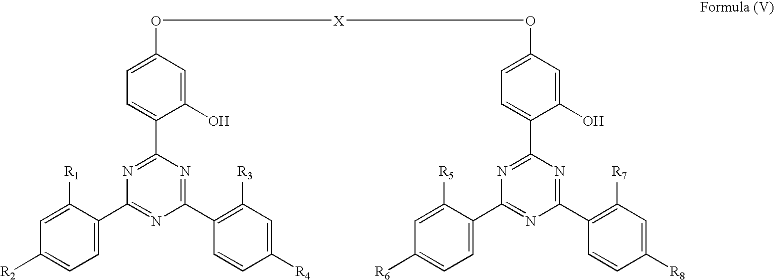
wherein
R₁, R₂, R₃, R₄, R₅, R₆, R₇, R₈ in formula (V) may be identical or different and represent H or alkyl or CN or halogen, and
X is alkyl or —(CH₂CH₂—O—)ₙ—C(═O)—

f) diaryl cyanoacrylates of formula (VI): 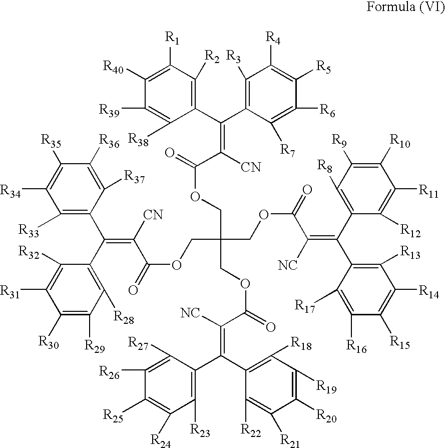
wherein R₁ to R₄₀ may be identical or different and represent H, alkyl, CN or halogen.

Of those compounds, preference is given to Uvinul® 3030 where R₁ to R₄₀═H.

The above-mentioned UV absorbers are known to the person skilled in the art, and some of them are available commercially.

The UV absorbers or mixtures thereof are usually present in concentrations of from 0 to 20 wt. %, preferably from 0.1 to 20 wt. %. If two or more co-extruded layers are present, the amount of UV absorber in those layers may be different.

Very particular preference is given to those multi-layer products in which the co-extruded layer(s) is(are) from 30 to 100 μm thick and contain(s) from 1 to 20 wt. %, particularly preferably from 2 to 10 wt. %, very particularly preferably from 3 to 8 wt. %, UV absorber. The UV absorber is preferably selected from the group containing Tinuvin® 360, Tinuvin® 1577 and Uvinul® 3030, in particular for the outer co-extruded layer.

The multi-layer products according to the invention are produced by means of co-extrusion, the substantially wedge-shaped spurs of the co-extruded layer, which extend at regular intervals into the base layer, being produced by means of a die of a suitable form. The present invention relates also to this process.

Co-extrusion as such is known in the literature (see, for example, EP-A 0 110 221 and EP-A 0 110 238). In the present case, the procedure is preferably as follows. Extruders for producing the core layer and covering layer(s) are attached to a co-extrusion adapter. The adapter is in such a form that the melt forming the covering layer(s) is applied in the form of a thin layer that adheres to the melt of the core layer. The multi-layer molten extrudate so produced is then brought into the desired form (solid or multi-wall sheet) in the following die. The die of a suitable form is characterised in that the flow channel (often referred to as the choke field) is formed by a plurality of parallel bores corresponding to the number of thin lines on the sheet, which bores open into a rectangular cross-section corresponding to the outlet gap shortly before the end of the die. The melt is subsequently cooled in known manner under controlled conditions by means of calendering (solid sheet) or vacuum calibration (multi-wall sheet) and then cut to length. A tempering oven may optionally be provided downstream of the calibration or calendering in order to eliminate stresses. Instead of the adapter arranged upstream of the die, it is also possible for the die itself to be of such a form that the melts are brought together therein.

Subsequent working of the multi-layer products according to the invention, for example by deep drawing or by surface working, e.g. provision with scratch-resistant coatings, water-repellent layers and the like, is, of course, also possible.

The present invention also provides a product containing a multi-layer product according to the invention, especially a solid or multi-wall sheet. Such products are preferably selected from the group consisting of glazing, greenhouse, conservatory, veranda, car port, bus stop, roofing, partition wall, cashier's box, display, advertising hoarding, traffic sign, lighting element, photovoltaic module and solar collector.

Although the invention has been described in detail in the foregoing for the purpose of illustration, it is to be understood that such detail is solely for that purpose and that variations may be made therein by those skilled in the art without departing from the spirit and scope of the invention except as it may be limited by the claims.

1. A co-extruded multi-layer article of manufacture comprising a base layer that contains a first transparent thermoplastic resin and at least one co-extruded layer that contains a second transparent thermoplastic resin, the co-extruded layer being different from the base layer, said co-extruded layer anchored in the base layer at regular intervals be a plurality of substantially wedge-shaped spurs.

2. The article of claim 1 wherein the base layer comprises polycarbonate.

3. The article of claim 1 wherein the second transparent thermoplastic resin is a member selected from the group consisting of (co)polycarbonate, (co)polyester polycarbonate-polyester blend and (co)polymethyl methacrylate.

4. The article of claim 1 wherein the co-extruded layer contains from 1 to 20 wt. % of at least one UV absorber.

5. The article of claim 1 wherein the co-extruded layer is from 30 to 100 μm in thickness.

6. The article of claim 4 wherein the UV absorber is selected from the group consisting of Tinuvin® 360, Tinuvin® 1577 and Uvinul® 3030.

7. The article of claim 1 wherein the base layer is in the form of a solid sheet.

8. The article of claim 1 wherein the base layer is in the form of a multi-wall sheet.

9. The article of claim 1 wherein the base layer contains (co)polycarbonate resin and where the co-extruded layer contains a member selected from the group consisting of (co)polycarbonate, (co)polyester polycarbonate-polyester blend and (co)polymethyl methacrylate.

10. The article of claim 1 comprising a base layer in the form of a solid or multi-wall sheet wherein the first transparent resin contains (co)polycarbonate and two co-extruded layers which are identical or different one from the other and each contains a member selected from the group consisting of (co)polycarbonate, (co)polyester, polycarbonate-polyester blend and (co)polymethyl methacrylate.
